(19) United States
(12) Patent Application Publication
(10) Pub. No.: US 2008/0231891 A1
(43) Pub. Date: Sep. 25, 2008

(54) CLIENT APPARATUS, SERVER APPARATUS, AND INFORMATION PROCESSING METHOD

(75) Inventor: Hiroaki Nakata, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/051,747

(22) Filed: Mar. 19, 2008

(30) Foreign Application Priority Data
Mar. 23, 2007 (JP) 2007-077099

(51) Int. Cl. G06F 15/00

(52) U.S. Cl. 358/1.15

(57) ABSTRACT

A client apparatus capable of communicating with a server apparatus via a network includes a collecting unit configured to collect module configuration information regarding at least one device driver installed in the client apparatus, a module configuration information transmitting unit configured to transmit the module configuration information collected by the collecting unit to the server apparatus, a complementary data receiving unit configured to receive, from the server apparatus, complementary data compensating for a difference between the module configuration information of the client apparatus and module configuration information of the server apparatus, and a complementing unit configured to complement the module configuration information of the client apparatus based on the complementary data received by the complementary data receiving unit.

### BACKGROUND OF THE INVENTION

1. Field of the Invention

The present invention relates to a client apparatus, a server apparatus, and an information processing method.

2. Description of the Related Art

Recently, the so-called “download install” technique has been developed to download a device driver, which is previously installed in a server (server apparatus), and to install the device driven in a client (client apparatus) for use in the client.

Among device drivers, one well-known example of a printer driver is Point&Print employed in Microsoft® Windows.

For example, when a user instructs execution of the Point&Print on a client, the client forms a “true connect” printer connection through Remote Procedure Call (RPC) when the Point&Print is executed.

When the RPC connection is formed, a printer driver and settings for a printer are downloaded from a print server to the client. Further, the client can automatically receive update data of module and device settings from the print server.

When the module and device settings of the printer driver are updated, the client receives the new settings in an asynchronous manner and executes a printing process by using the updated printer driver.

Meanwhile, the so-called “plug-in” scheme is also well known which enables an additional function to be freely attached to or detached from a base program.

The plug-in scheme is applied to not only general application software, but also to a printer driver, i.e., one of device drivers, with more progresses in development.

Because the printer driver operates under the control of a printing service is incorporated in an operating system (OS), the printer driver can also be regarded as one kind of plug-in with respect to the printing service.

In addition, researches have been progressed for a further plug-in method of adding and deleting a module, e.g., a program file or a data file, to and from the printer driver that has already been installed.

Japanese Patent Laid-Open No. 2005-208895 proposes a system capable of correctly installing a plug-in module under control of the printer driver even in a system, e.g., Point&Print, installed under control of the OS.

Windows Vista employs an installation method called Package Point&Print, which is a new version of the earlier Point&Print and has improved security.

The Package Point&Print is the installation method in which an install set, called a “package” and previously registered in the OS, is first downloaded to a client and a setup is then executed.

Stated another way, in the Package Point&Print, installation is executed by using the package, which is the install set before being installed, instead of the printer driver after being installed.

Because the install set before being installed is electronically signed, the Package Point&Print has higher reliability than the earlier Point&Print.

### SUMMARY OF THE INVENTION

According to an aspect of the present invention, in a client apparatus configured to communicate with a server apparatus, the client apparatus includes a collecting unit configured to collect module configuration information regarding at least one device driver installed in the client apparatus, a module configuration information transmitting unit configured to transmit the module configuration information, a complementary data receiving unit configured to receive, from the server apparatus, complementary data compensating for a difference between module configuration information of the client apparatus and module configuration information of the server apparatus, and a complementing unit configured to complement the module configuration information of the client apparatus based on the complementary data.

With the present invention, the difference in module configuration between the server apparatus and the client apparatus can be eliminated.

Other aspects and features of the present invention will be apparent from the following description taken in conjunction with the accompanying drawings, in which like reference characters designate the same or similar parts throughout thereof.

### BRIEF DESCRIPTION OF THE DRAWINGS

FIG. 1 illustrates one example of a configuration of a print server system.

FIG. 2A is a block diagram illustrating an example of a hardware configuration of a print server.

FIG. 2B is a block diagram illustrating one example of a hardware configuration of a client computer.

FIG. 3 is a functional block diagram illustrating modules related to installation of a printer driver with the Point&Print.

FIG. 4 illustrates an installation flow with the Point&Print.

FIG. 5 is a block diagram illustrating a plug-in for a printer driver installed in the print server.

FIG. 6 is a functional block diagram illustrating modules related to installation with the Package Point&Print.

FIG. 7 illustrates an installation flow with the Package Point&Print.

FIG. 8 is a flowchart illustrating a processing flow according to a module installation method in the print server system.

FIG. 9A is an illustration (No. 1) representing a difference between modules (in module configuration).

FIG. 9B is an illustration (No. 2) representing a difference between modules (in module configuration).

FIG. 9C is an illustration (No. 3) representing a difference between modules (in module configuration).

FIG. 10 is a flowchart illustrating, in more detail, a process of collecting client device driver configuration information in step S100 of FIG. 8.

FIG. 11 illustrates one example of a data format of the client device driver configuration information.

FIG. 12 is a flowchart illustrating, in more detail, a process of comparing the module configurations in step S300 of FIG. 8.

FIG. 13 illustrates one example of a data format of complementary data.

FIG. 14 is a flowchart illustrating, in more detail, a process of executing a complementation setup in accordance with complementary data in step S600 of FIG. 8.

FIG. 15 illustrates one example of a user interface (UI) used to start synchronization of the module configuration.

### DESCRIPTION OF THE EMBODIMENTS

Exemplary embodiments of the present invention will be described below with reference to the drawings.

### First Exemplary Embodiment

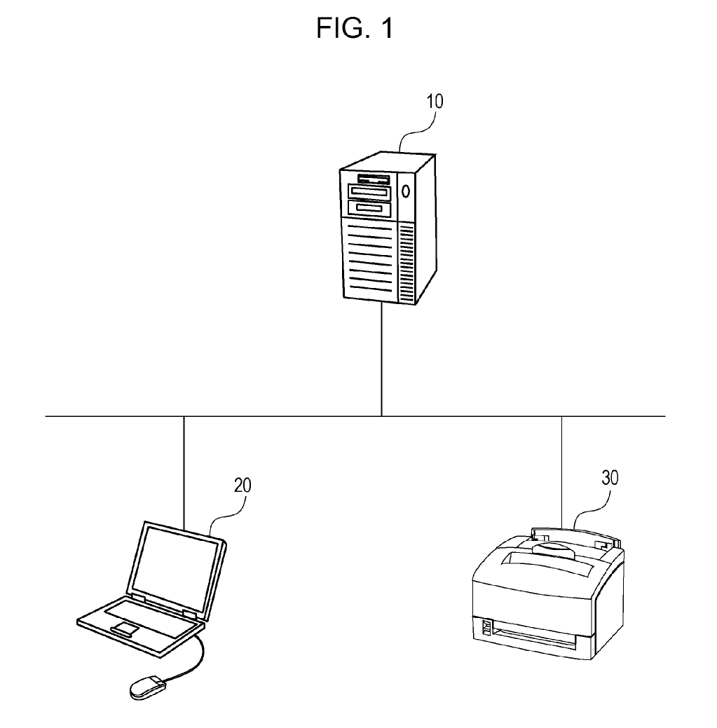

FIG. 1 illustrates one example of a configuration of a print server system.

As illustrated in FIG. 1, the print server system includes a print server 10, a client computer 20, and a printer (printing apparatus) 30. Those components are interconnected via a network to be able to communicate with one another.

The print server 10 mediates printing data input from the client computer 20 and outputs the printing data to the printer 30 for printing it.

To that end, the print server 10 incorporates not only at least one program (application or service) with a printing function, but also a printer driver for mediating the printing from the application to the printer 30. Further, the client computer 20 usually incorporates at least one program with a printing function, which is similar to that incorporated in the print server 10.

In order that a use of the client computer 20 executes the printing by utilizing the printer 30, the same printer driver as that incorporated in print server 10 has to be incorporated in the client computer 20.

The reason is that the printing data produced by the application in the client computer 20 is required to be mediated by the printer driver on the print server 10 before the printing data is input to the printer 30. Further, in order to enable the printer driver on the print server 10 to mediate the printing data, the printing data is required to be mediated by the same printer driver on the client computer 20.

In the print server system, therefore, the same printer driver as that installed in the print server 10 has to be installed in the client computer 20.

Such an installing operation in the client computer 20, however, imposes a burden on the user of the client computer 20.

The Point&Print is known as a scheme for solving the above-described problem.

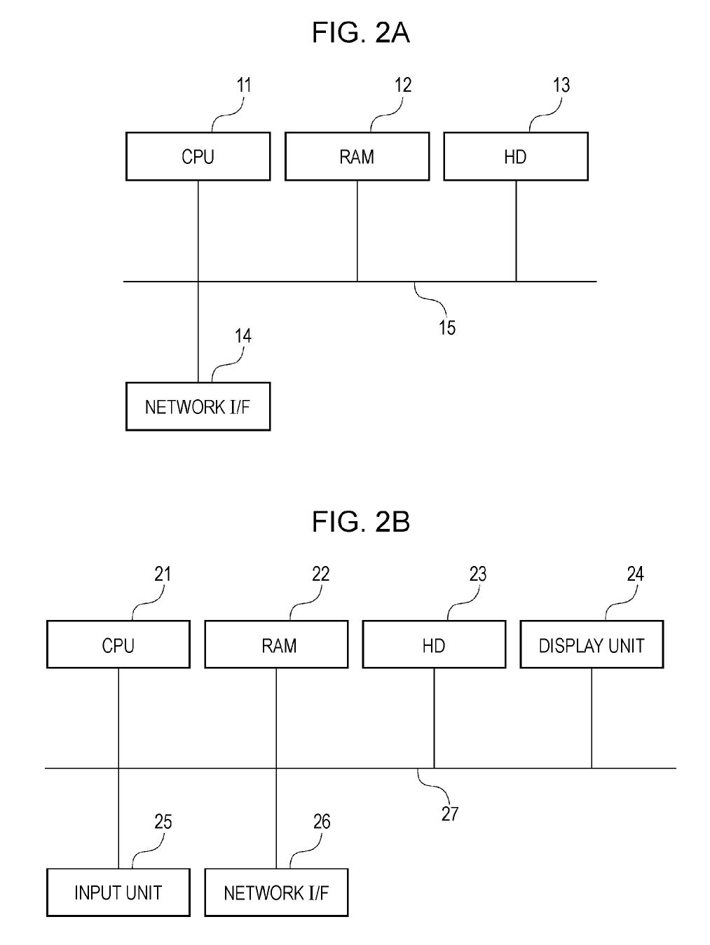

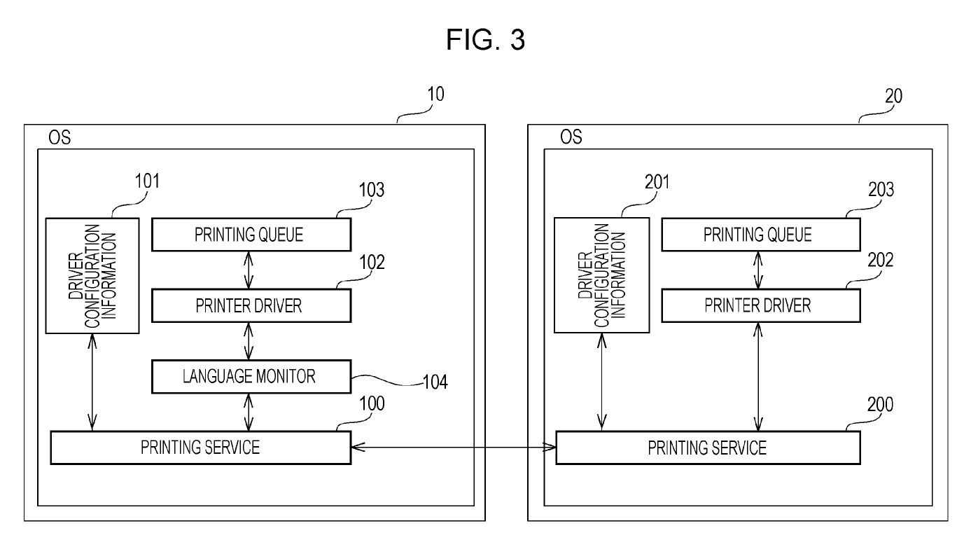

An installation flow with the Point&Print will be described below with reference to FIGS. 2 and 3.

FIG. 2A is a block diagram illustrating one example of a hardware configuration of the print server 10.

As illustrated in FIG. 2A, the hardware configuration of the print server 10 includes a Central Processing Unit (CPU) 11, a Random Access Memory (RAM) 12, a hard disk (HD) 13, and a network interface (I/F) 14. Those components are interconnected via a bus 15.

The CPU 11 executes processing related to functions of the print server 10, etc. in this exemplary embodiment in accordance with programs loaded in the RAM 12. The RAM 12 has a memory area for storing various programs and a memory area serving as a work area that temporarily stores (holds) various data when the CPU 11 executes the processing.

In the HD 13, an OS and various programs are installed beforehand. The programs installed in the HD 13 are loaded into the RAM 12 at the startup of the print server 10 or in response to an instruction for the startup of each program, and they are executed under control of the CPU 11.

The network I/F 14 serves as an interface unit for connecting the print server 10 to a network. The print server 10 can further include, as the additional hardware configuration, a display unit and an input unit similarly to the client computer 20 (described below).

FIG. 2B is a block diagram illustrating one example of a hardware configuration of the client computer 20.

As illustrated in FIG. 2B, the hardware configuration of the client computer 20 includes a CPU 21, a RAM 22, a hard disk (HD) 23, a display unit 24, an input unit 25, and a network I/F 26. Those components are interconnected via a bus 27.

The CPU 21 executes processing related to functions of the client computer 20, etc. in this exemplary embodiment in accordance with programs loaded in the RAM 22. The RAM 22 has a memory area for storing various programs and a memory area serving as a work area that temporarily stores (holds) various data when the CPU 21 executes the processing.

In the HD 23, an OS and various programs are installed beforehand. The programs installed in the HD 23 are loaded into the RAM 22 at the startup of the client computer 20 or in response to an instruction for the startup of each program, and they are executed under control of the CPU 21.

The display unit 24 is, for example, a CRT or a liquid crystal display that displays a user interface.

The input unit 25 includes a pointing device, such as a keyboard or a mouse, to input data corresponding to user's operations.

The network I/F 26 serves as an interface unit for connecting the client computer 20 to the network.

FIG. 3 is a functional block diagram illustrating modules related to installation of a printer driver with the Point&Print.

A printing service 100 in the print server 10 is a service program for controlling a printing process and the installation of the printer driver on the OS in the print server 10.

In the Windows OS, a Spooler service corresponds to the printing service 100. The Spooler service provides means for utilizing various functions, such as transmission of printing data to a printer, installation of a printer driver, and the Point&Print.

More specifically, the Spooler service provides means for realizing the above-described functions by making function interfaces, collectively called API (Application Program Interface), open to the public. In other words, applications and the printer driver execute processing via the API.

It is assumed here that the printing service 100 in this exemplary embodiment also has similar functions to those of the Spooler service.

Driver configuration information 101 represents driver configuration information (module configuration information) of a printer driver 102 in the print server 10, and is stored in a shared memory area of the OS. Based on the driver configuration information 101, the printing service 100 and the printer driver 102 each installed as a part of the OS can recognize attachment and detachment of a plug-in.

A printing queue 103 is a virtual queue that serves to temporarily store the printing data before the printing data is output to the printer 30.

A language monitor 104 sends data to the printer driver 102 (or the printer 30) while analyzing the printing data sent from the printing service 100, and further responses to a request, from the program, for acquiring printer configuration information and print server configuration information.

Although the language monitor 104 and the printer driver 102 are separately illustrated in FIG. 3, the language monitor 104 is recognized as a part of the printer driver 102 when viewed from the printing service 100.

Similarly to the printing service 100 in the print server 10, a printing service 200 in the client computer 20 controls a printing process and installation of a printer driver on the OS of the client computer 20.

Note that, before execution of the Point&Print, a printer driver 202, driver configuration information 201, and a printing queue 203 are not present on the client computer 20.

The printer driver 202, the driver configuration information 201, and the printing queue 203 are incorporated in the client computer 20 with the Point&Print.

Because the language monitor 104 is functionally positioned outside the Point&Print, it is not downloaded to the client computer 20.

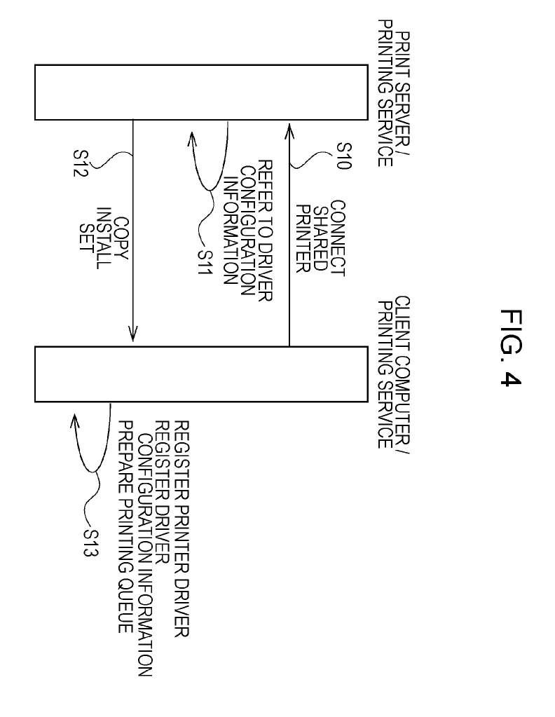

FIG. 4 illustrates an installation flow with the Point&Print. The user of the client computer 20 makes a connection to a shared printer via the printing service 200 in the client computer 20 and issues a request for the Point&Print (S10).

In response to the request, the printing service 100 in the print server 10 refers to the driver configuration information 101 and decides an install set to be downloaded (S11).

In cooperation with the printing service 200 in the client computer 20, the printing service 100 copies the install set for the printer driver 102 in the print server 10 into the client computer 20 (S12).

Based on the copied install set, the printing service 200 in the client computer 20 registers the printer driver 202 on the OS of the client computer 20. At the same time, the printing service 200 registers the driver configuration information 201 and prepares the printing queue 203 (S13).

As a result, the user of the client computer 20 can operate the printer 30 so as to execute printing via the print server 10.

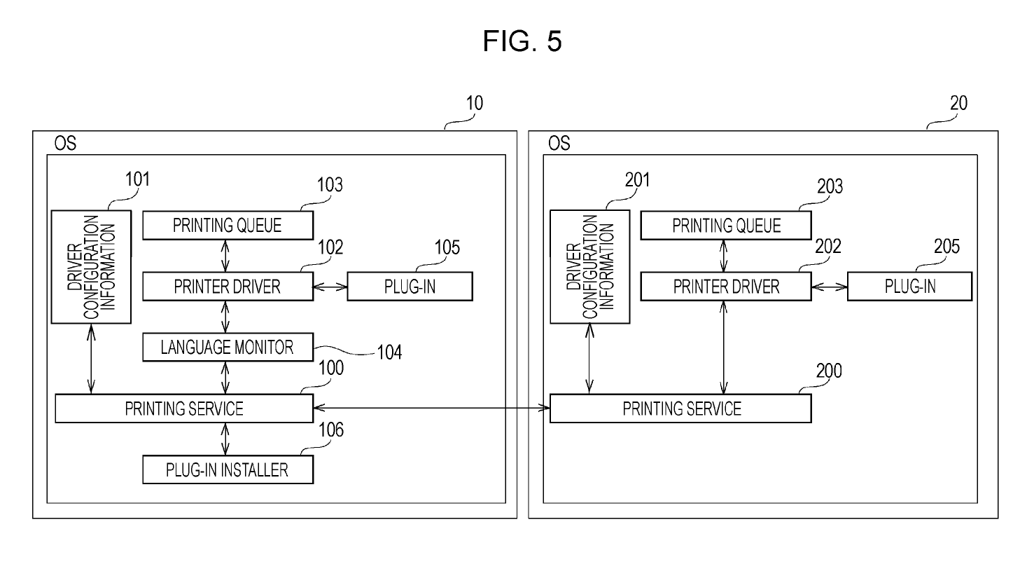

FIG. 5 is a block diagram illustrating a plug-in 105 for the printer driver 102 installed in the print server 10. The plug-in 105 is, for example, a file group including program files, e.g., a DLL (Dynamic Link Library).

The plug-in 105 is additionally installed by a plug-in installer 106 such that it can communicate with a common extension interface of the printer driver 102 and can realize functional extension.

In other words, the plug-in installer 106 is a program that is executable when the printer driver 102 is in the installed state. Also, the plug-in 105 operates as a part of the printer driver 102.

Practical examples of the functional extension realized with the plug-in 105 includes a function of collecting the history of printing jobs, a function of adding a background image to the printing data, etc.

When the plug-in 105 is additionally installed, the plug-in installer 106 adds the information of the plug-in 105 to the driver configuration information 101.

Accordingly, the printing service 100 and the printer driver 102 are caused to recognize the plug-in 105 as a part of the printer driver 102.

With the above-described Point&Print process, therefore, the printer driver 102 and the plug-in 105 as a part of the former are downloaded and installed in the client computer 20 as the printer driver 202 and a plug-in 205, respectively.

As a result, the printer drivers in the print server 10 and the client computer 20 have the same module configuration. Hence, the user of the client computer 20 can utilize the function of the plug-in 105 (plug-in module) that has been incorporated later.

As mentioned above, the language monitor 104 is not downloaded, as an exceptional module, to the client computer 20. While remaining in the print server 10, the language monitor 104 operates for the printer driver 202 in the client computer 20 in a similar manner for the printer driver 102 in the print server 10.

More specifically, for example, the printer driver 202 in the client computer 20 instructs the printing service 200 to call the API using the function of the language monitor 104. Responsively, the printing service 200 calls the language monitor 104 via the printing service 100 in the print server 10.

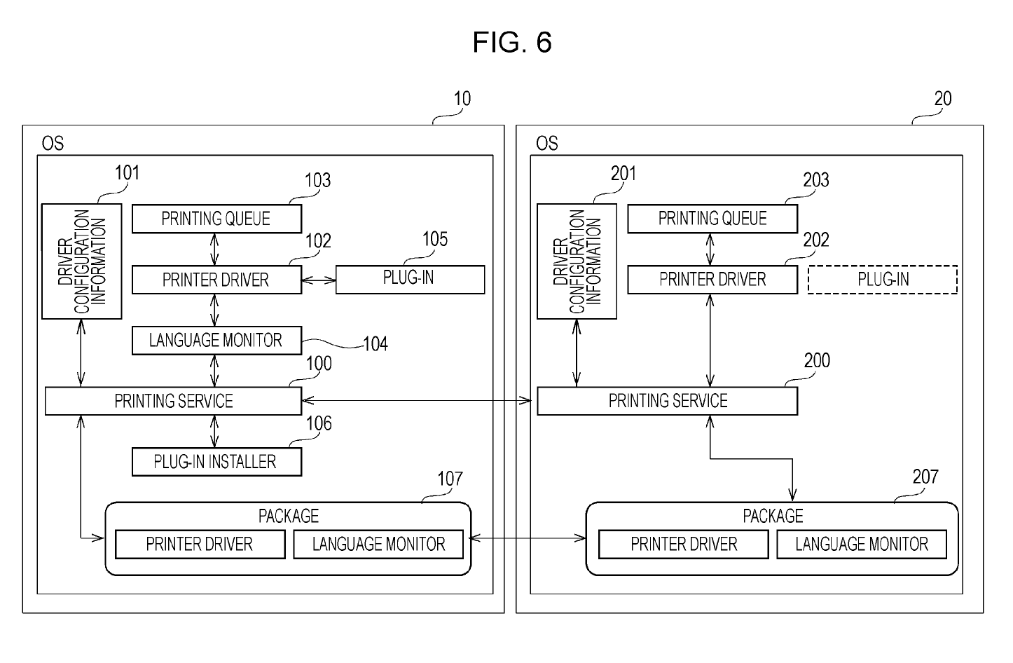

FIG. 6 is a functional block diagram illustrating modules related to installation with the Package Point&Print.

A package 107 in the print server 10 represents a file group that is used to install the printer driver 102 and the language monitor 104 as a part of the former and is registered in the OS.

When the installation is performed by using a driver install set distributed via media, e.g., a CD-ROM, or a network, the package 107 is stored and registered as a backup in the OS.

The use of the package 107 is beneficial, for example, in that when the driver is erased by a mistake, it can be installed immediately with no need of seeking again the media for the installation.

Note that, because the plug-in 105 is installed by the plug-in installer 106, the plug-in 105 is not included in the package 107.

On the other hand, the printer driver 202, the printing queue 203, and the package 207 are not present in the client computer 20 before the Package Point&Print is executed.

The Package Point&Print differs from the above-described Point&Print in that the package is used in the former to install the driver in the client computer 20.

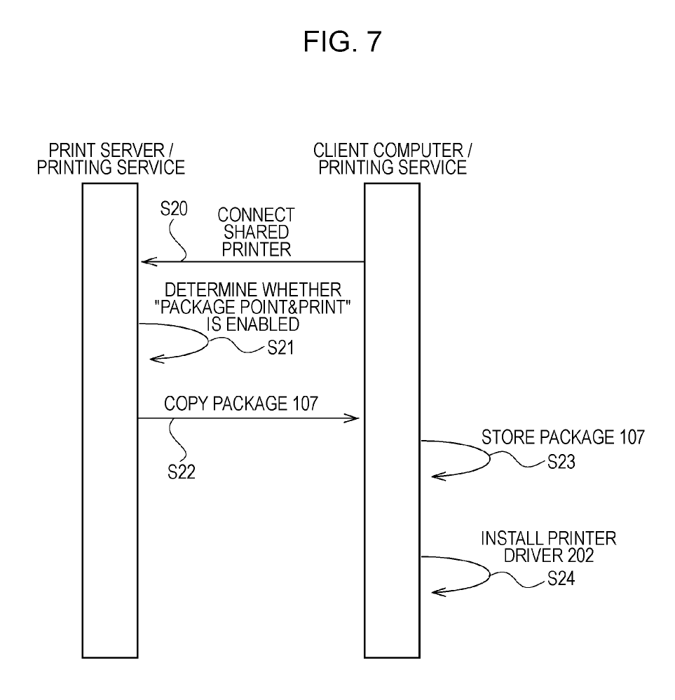

A processing flow with the Package Point&Print will be described next with reference to FIG. 7.

FIG. 7 illustrates an installation flow with the Package Point&Print.

As with the Point&Print, the user of the client computer 20 makes a connection to the shared printer via the printing service 200 in the client computer 20 and issues a request for the Package Point&Print (S20).

In response to the request, the printing service 100 in the print server 10 determines whether the Package Point&Print can be executed between the print server 10 and the client computer 20 (S21).

If the determination result indicates that the Package Point&Print can be executed, the printing service 100 in the print server 10 copies the package 107, which is registered in the print server 10, into the client computer 20 in cooperation with the printing service 200 in the client computer 20 (S22).

Then, the printing service 200 registers the copied package 207 as a package on the OS of the client computer 20 (S23).

Finally, the printing service 200 installs the printer driver 202 from the package 207 (S24).

At that time, as in the above-described case, the language monitor included in the package is not installed in the client computer and it fulfills the function while remaining in the print server 10.

Thus, the user of the client computer 20 can perform printing, etc., by using the printer driver 102 registered in the print server 10.

It is, however, apparent that the copied package does not include the plug-in 105 installed later in the print server 10. Therefore, the user of the client computer 20 cannot utilize the function added by the plug-in 105.

Further, with the Package Point&Print, the client computer 20 cannot receive module update from the print server 10 for the sake of security. Accordingly, the plug-in 105 cannot be downloaded to the client computer 20.

One conceivable method of installing the plug-in 105 into the client is to previously incorporate the plug-in 105 in the package 107 at the same time as when the plug-in installer 106 installs the plug-in 105.

However, the package is electronically signed. Hence, if the configuration of the file group included in the package is changed or if any file is rewritten, such tampering or substitution is detected by the OS and the Package Point&Print is not executed.

A process or method for coping with the above-described problem will be described in detail below.

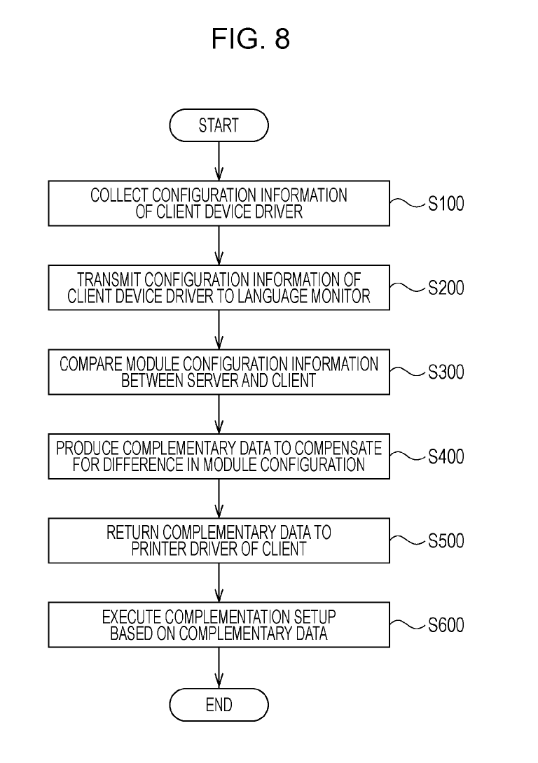

FIG. 8 is a flowchart illustrating a processing flow according to a module installation method in the print server system.

The processing illustrated in FIG. 8 is started from the state in which the printer driver 202 is installed in the client computer 20 without including the plug-in 105 according to the Package Point&Print process described with reference to FIGS. 6 and 7.

More specifically, at the completion of the installation, the printing service 200 in the client computer 20 transmits, to the printer driver 202 through the API, a notification indicating that the Point&Print or the Package Point&Print has been completed.

Upon receiving the notification, the printer driver 202 starts processing as follows.

In step S100, the printer driver 202 collects client device driver configuration information (driver configuration information 201 of the client computer 20), i.e., information in the client side which is required for synchronization of the module configuration with the print server 10. Details of the processing in step S100 will be described in detail later with reference to FIG. 10.

### (Transmission of Module Configuration Information)

Then, in step S200, the printer driver 202 transmits the collected client device driver configuration information to the language monitor 104 in the print server 10 via the printing service, etc.

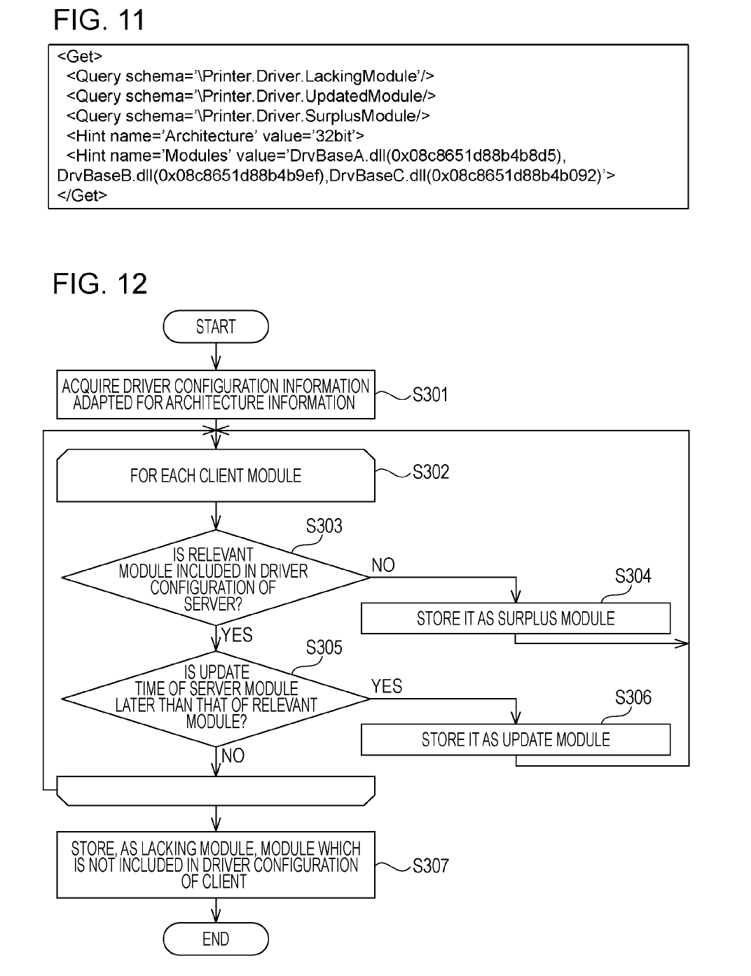

Details of a data format of the client device driver configuration information, transmitted in step S200, are illustrated in FIG. 11 described later.

### (Reception of Module Configuration Information and Detection of Difference)

In step S300, the language monitor 104 (or the printer driver 102) compares the module configuration between the print server 10 and the client computer 20 based on the received client device driver configuration information. Details of the processing in step S300 will be described in detail later with reference to FIG. 12.

### (Preparation of Complementary Data)

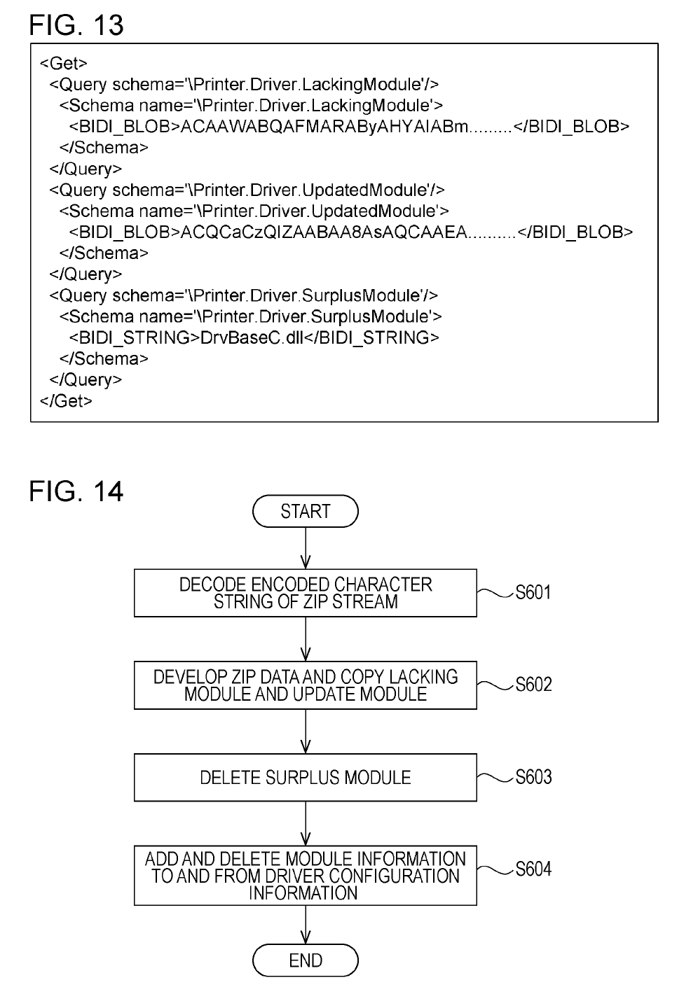

In step S400, the language monitor 104 (or the printer driver 102) produces complementary data compensating for the difference in the module configuration based on the comparison result in step S300. Details of a data format of the complementary data produced in step S400 are illustrated in FIG. 13 described later.

### (Transmission of Complementary Data)

In step S500, the language monitor 104 (or the printer driver 102) replies (or transmits) the produced complementary data to the printer driver 202 in the client computer 20 via the printing service, etc.

### (Reception of Complementary Data and Complementation of Module Configuration)

Finally, in step S600, the printer driver 202 executes a complementation setup (complementation of the module configuration) based on the replied complementary data. Details of the processing in step S600 will be described in detail later with reference to FIG. 14.

A description is now made of a method for transmitting and receiving data between the printer driver 202 in the client computer 20 and the language monitor 104 in steps S200 and S500.

As described above, the language monitor 104 executes control for responding to the request, from the program, for acquiring the printer configuration information and the print server configuration information. The program can utilize the function provided by the printing service 100 through the API that is made open to the public by the printing service 100.

In such a case, for example, the printer driver 202 in the client computer 20 instructs the printing service 200 to call the API using the function of the language monitor 104. Responsively, the printing service 200 calls the language monitor 104 through the printing service 100 in the print server 10.

One of the functions provided by the language monitor 104 through the API is to transmit query information to the language monitor 104 and to receive information in response to the query information.

A typical example of the query information is the printer configuration information indicating, e.g., the attached or detached state of a duplex unit or a finisher. Another example of the query information is the setting information held by the printer driver.

In this exemplary embodiment, the printer driver 202 in the client computer 20 transmits and receives, in addition to its own function as the printer driver, the information (via the printing service) by using the query function of the API in order to establish the synchronization of the module configuration.

Using the API of the language monitor 104 is beneficial in that processing can be simplified because all processes specialized for communication, such as a communication protocol and timings, can be executed by the respective printing services in the client computer 20 and the print server 10.

Of course, a similar object can also be achieved by performing communication with the printing service in the print server 10 by using the HTTP or another specific communication protocol.

The difference in the module configuration between the print server 10 and the client computer 20 will be described next.

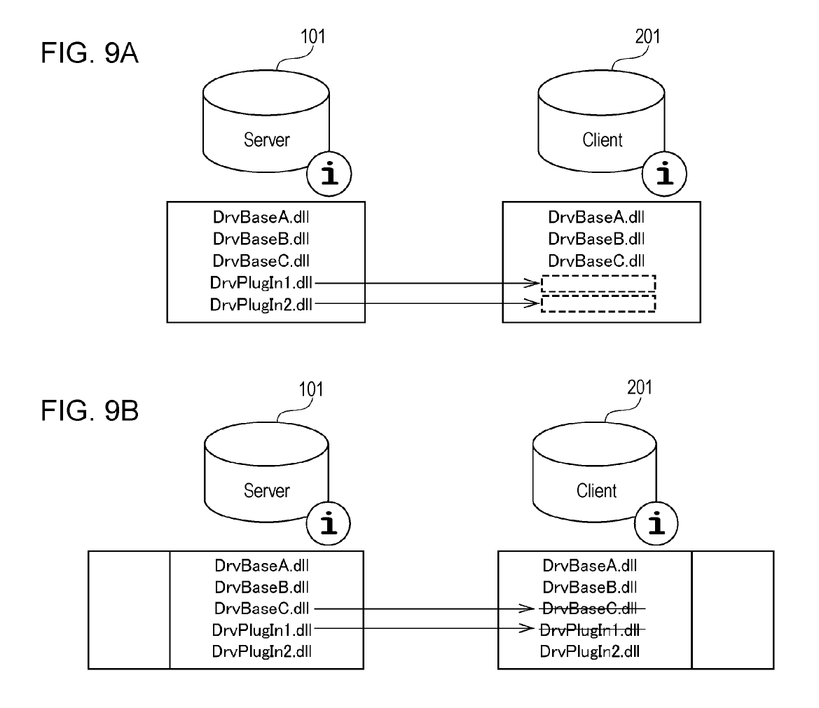

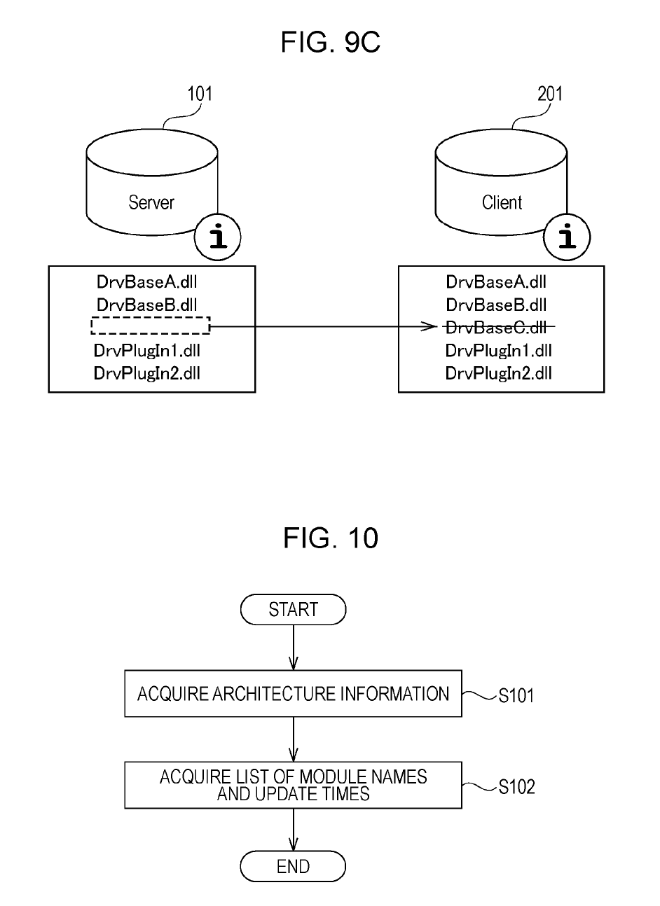

FIGS. 9A, 9B and 9C are each an illustration representing the difference between modules (difference in module configuration).

FIG. 9A illustrates one example of the case that some module is present in the server side (i.e., in the print server 10), but it is not present in the client side (i.e., in the client computer 20).

More specifically, in the state illustrated in FIG. 9A, two files, i.e., DrvPlugIn1.d11 and DrvPlugIn2.d11, are lacked in the client side.

That state is caused for the reason that a plug-in additionally installed in the server side later is neither downloaded nor installed into the client side with the Package Point&Print. Namely, that state represents one type of difference to be eliminated.

FIG. 9B illustrates one example of the case that some module in the server side has a later update time than a corresponding module in the client side.

More specifically, in the state illustrated in FIG. 9B, each of two files, i.e., DrvBaseC.d11 and DrvPlugIn1.d11, has a later update time than that of a corresponding file in the client side.

That state is caused for the reason that the driver modules in the server side are partly updated after it has been downloaded and installed into the client side. Namely, that state represents another type of the difference to be eliminated.

FIG. 9C illustrates one example of the case that some module in the client side is no longer present in the server side.

More specifically, in the state illustrated in FIG. 9C, a file, i.e., DrvBaseC.d11, is no longer present in the server side.

That state is caused for the reason that, after some plug-in module has been downloaded and installed into the client side, it is uninstalled and removed from the server side. Namely, that state represents still another type of the difference to be eliminated.

FIG. 10 is a flowchart illustrating, in more detail, the process of collecting the client device driver configuration information in step S100 of FIG. 8.

In step S101, the printer driver 202 acquires architecture information of the client computer 20. The architecture information is, for example, information regarding hardware, such as 32 bit of Intel (registered trademark) or 64 bit of AMD (registered trademark).

In the case of the server side and the client side having different architectures, upon receiving a connection request for the Point&Print, the printing service 100 in the server side copies a printer driver having an architecture adapted for the client side, or its package.

The reason is that a program module, such as a DLL (Dynamic Link Library), usually has no compatibility between different architectures of hardware on each of which the OS is operating.

Accordingly, a plug-in module, i.e., a program module such as a DLL, is also required to be downloaded to provide the same architecture in the printer driver 202 in the client side to which the downloaded plug-in will belong as its part. To that end, the printer driver 202 collects the architecture information as one item of information transmitted to the server side.

Then, in S102, the printer driver 202 accesses the driver configuration information 201 and acquires a list of module names and update times. Note that the printer driver 202 can acquire the driver configuration information 201 through the API provided by the printing service 200.

With the processing illustrated in FIG. 10, a list of the names of modules constituting the printer driver 202 can be obtained. Further, the update time of each module can also be obtained, for example, by using the API of the OS.

FIG. 11 illustrates one example of a data format of the client device driver configuration information.

The information obtained in steps S101 and S102 are brought together into one data format by the printer driver 202 as information used for query to the language monitor 104. The data format is decided depending on the API of the language monitor 104. In the example of FIG. 11, the information is described within data in the XML (Extensible Markup Language) format.

More specifically, a character string written in the “Schema” attribute of the “Query” element represents the information used for query to the language monitor 104.

The example of FIG. 11 includes the following three descriptions:
LackingModule (representing a lacking module that is lacked in the client side)
UpdateModule (representing an update module that is updated in the server side)
SurplusModule (representing a surplus module that is no longer used in the server side)

Further, the “Hint” element lists information used by the language monitor 104 for providing a response. In the “Hint” element, the “name” attribute represents the name of an information item, and the “value” attribute represents a value regarding the information.

In the example of FIG. 11, “32 bit” is described, as a character string value, in the item of “Architecture” (representing the architecture information).

Further, in the example of FIG. 11, a list of module names individually marked off by commas (,) is described, as character string values, in the item of “Modules” (representing the modules).

Note that a numerical value put in a parenthesis following each name expresses the latest update time of the corresponding module.

The printer driver 202 uses the XML data, such as illustrated in the example of FIG. 11, as an input to the API for query to the language monitor 104.

FIG. 12 is a flowchart illustrating, in more detail, the process of comparing the module configurations in step S300 of FIG. 8.

The language monitor 104 is called in step S200 (FIG. 8) through the API for the query to the printing service 100 and starts the following process upon receiving data of the client device driver configuration information.

In step S301, the language monitor 104 acquires the driver configuration information 101 adapted for the architecture information that is included in the client device driver configuration information 201.

As described above, the Point&Print can be executed even when the printer drivers differ in architecture between the server side and the client side. Therefore, a plurality of printer drivers having different architectures are often registered (or installed) in the apparatus. In such a case, it is required to establish synchronization of the module configuration with the printer driver that is adapted for the architecture in the client side. Accordingly, the language monitor 104 has to acquire the driver configuration information 101 adapted for the architecture in the client side.

Then, in step S302, the language monitor 104 repeats processing of steps S303 to S306 for each of all modules in the module configuration included in the client device driver configuration information.

In step S303, the language monitor 104 determines whether the name of each module in the client computer 20 is included in the list of the module names that are provided as the driver configuration information 101 of the print server 10.

If the module name is not included in the list, the language monitor 104 determines that the relevant module is a module which is no longer present in the print server 10 and is surplus (i.e., a surplus module). The language monitor 104 then advances to step S304. On the other hand, if the module name is included in the list, the language monitor 104 advances to step S305.

In step S304, the language monitor 104 stores the name of the relevant module as the surplus module and returns to step S302 again. The surplus module is a module that is generated, for example, when some plug-in has become no longer required after the installation and it has been uninstalled.

In step S305, the language monitor 104 compares the update time of each module in the client computer 20 with the update time of the corresponding module in the print server 10. If the update time of the module in the print server 10 is later than the update time of the corresponding module in the client computer 20, the language monitor 104 determines that the relevant module in the print server 10 is an update module. The language monitor 104 then advances to step S306. If otherwise, the language monitor 104 returns to step S302.

In step S306, the language monitor 104 stores the name of the relevant module as the update module and returns to step S302 again. The update module is a module that is generated, for example, when some plug-in has been updated in the server side.

When the above-described processing is repeated and completed for all the client modules, the language monitor 104 advances to step S307.

In step S307, the language monitor 104 stores the server module, which is not included in the module configuration in the client side, as the lacking module that is lacked in the client. The lacking module is a module that is generated, for example, when the downloading and the installation are performed with the Package Point&Print without downloading the plug-in.

A list of the modules stored in the above-described processes, including the surplus module, the update module, and the lacking module, is utilized when the complementary data is produced in step S400 (FIG. 8).

FIG. 13 illustrates one example of a data format of the complementary data.

The data format of the complementary data is also decided depending on the API of the language monitor 104. In the example of FIG. 13, the information is described within data in the XML format.

More specifically, the “name” attribute in the “Schema” attribute under the “Query” element represents the information used for query and stores data of the returned information.

Each of “LackingModule” (representing the lacking module) and “UpdateModule” (representing the update module) stores data in the binary format, and “SurplusModule” (representing the surplus module) stores data in the character string format.

Herein, the binary data in each of “LackingModule” and “UpdateModule” is provided as an encoded character string expressing a ZIP archive in which various file groups are collected together into one archive.

The data in the character string format, put in “SurplusModule”, is provided by expressing the list of the names of the modules, which are no longer used in the print server 10, while the individual names are marked off by commas (,).

FIG. 14 is a flowchart illustrating, in more detail, the process of executing the complementation setup in accordance with the complementary data in step S600 of FIG. 8.

When the printer driver 202 in the client computer 20 receives the complementary data, illustrated in FIG. 13, from the language monitor 104 through the printing service 200 in step S500 (FIG. 8), the printer driver 202 starts the following process.

In step S601, the printer driver 202 decodes the encoded character string in the ZIP archive contained in the complementary data, into which the file groups including the lacking module and the update module are collected together.

Because the encoding format of a character string is general one, such as “base64” encoding, the encoded character string can also be decoded in accordance with a standard procedure.

Then, in step S602, the printer driver 202 develops, as a file, the data contained in the ZIP archive and copies the file into an install directory of the printer driver.

At that time, the file group including the update module is already present in the install directory of the client computer 20. However, because this process is intended to update the modules in the client computer 20 in consistency with those in the print server 10, the printer driver 202 performs the copying through overwrite.

The lacking module is not present in the client computer 20. Therefore, the lacking module is copied as it is without overwrite.

Then, in step S603, the printer driver 202 reads the information of the surplus module included in the complementary data and deletes the file of the surplus module from the install directory of the printer driver.

Finally, in step S604, the printer driver 202 adds the information of each module (name and update time), which has been copied as the lacking module, to the driver configuration information 201 and also deletes the information of each module, which has been deleted as the surplus module, from the driver configuration information 201.

Further, the printer driver 202 renews the update time of the module that is described in the driver configuration information 201 and that has been overwritten as the update module.

Through the above-described process, the printer driver 102 in the server side and the printer driver 202 in the client side can have the same module configuration.

### Second Exemplary Embodiment

The first exemplary embodiment has been described above in connection with the case of eliminating the inconsistency in the module configuration between the print server 10 and the client computer 20 by starting the process at the time when the printer driver 202 is installed in the client computer 20. However, the process of eliminating the inconsistency in the module configuration can also be started at one of other timings.

The other timings include, for example, the timing at which the user opens the user interface to perform the printing setting of the printer driver 202, and the timing at which the printer driver 202 starts a printing process in response to an instruction from, e.g., an application.

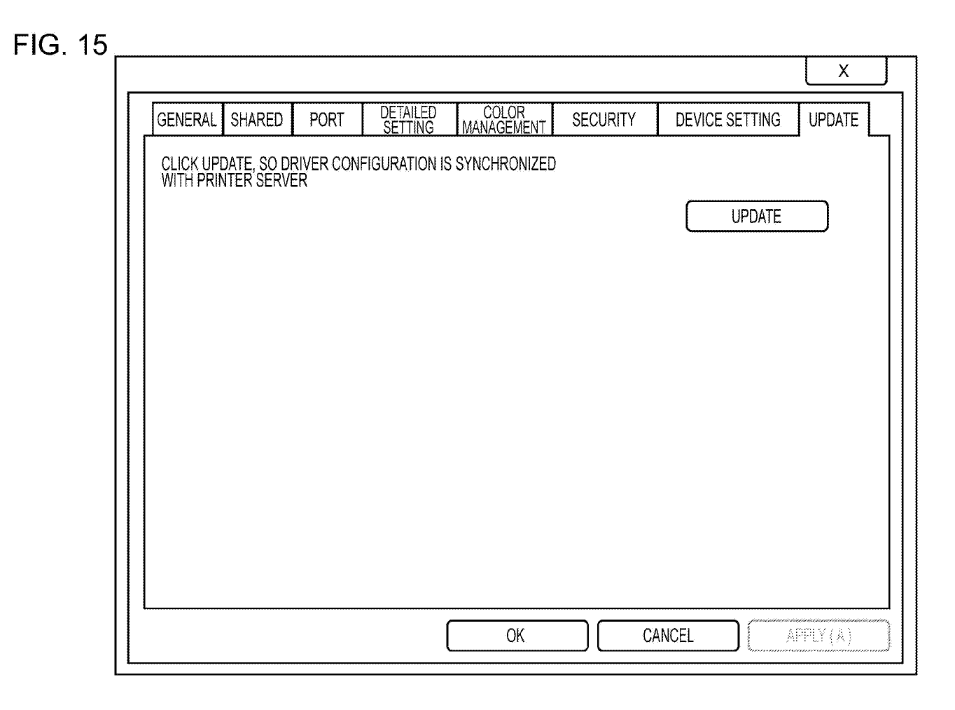

Further, the client computer 20 can start the process for synchronization with the print server 10 when the user presses an update button on a user interface (UI) illustrated in FIG. 15. FIG. 15 illustrates one example of the user interface used to start the synchronization of the module configuration.

### Other Exemplary Embodiments

The present invention can also be practiced as follows. A storage medium (or a recording medium) recording program code of software for implementing the functions of the above-described exemplary embodiment(s) is supplied to a system or an apparatus. A central processing unit (CPU or MPU) in the system or the apparatus reads and executes the program code stored in the storage medium. In that case, the program code read out from the storage medium serves in itself to implement the functions of the above-described exemplary embodiment(s). Therefore, the storage medium storing the program code also constitutes the present invention.

Further, when the central processing unit in the system or the apparatus executes the read-out program code, an OS (operating system), etc. running on the system or the apparatus can execute a part or the whole of actual processing in accordance with instructions from the program code. The functions of the above-described exemplary embodiment(s) can be implemented with the processing executed by the OS.

In addition, the program code read out from the storage medium can be written in a memory which is provided in a function extension card inserted in the system or the apparatus, or in a function extension unit connected to the system or the apparatus. Then, a part or the whole of the actual processing can be executed by a CPU or the like, which is incorporated in the function extension card or the function extension unit, in accordance with instructions from the program code. The functions of the above-described exemplary embodiment(s) can also be implemented with the processing executed by the CPU.

When the present invention is applied to the storage medium, the program code corresponding to the above-described flowcharts is stored in the storage medium.

According to the above-described exemplary embodiments, consistency in the module configuration can be ensured between the server-side driver and the client-side driver, the latter being downloaded and installed with the Package Point&Print.

As a result, even when a plug-in module is added to the driver installed in the server side, the plug-in module can also be downloaded to the client side and set up therein. In other words, the module configurations in the server side and the client side can be set to the same configuration.

Further, even when a driver is previously installed in the client side with the Package Point&Print, the consistency between the client-side driver and the server-side driver can be realized by starting the complementation process at the timing when the UI is opened, or when an instruction is entered through the UI, or when printing is started.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Application No. 2007-077099 filed Mar. 23, 2007, which is hereby incorporated by reference herein in its entirety.

What is claimed is:

1. A client apparatus configured to communicate with a server apparatus, the client apparatus comprising:
a collecting unit configured to collect module configuration information regarding at least one device driver installed in the client apparatus;
a module configuration information transmitting unit configured to transmit the module configuration information;
a complementary data receiving unit configured to receive, from the server apparatus, complementary data compensating for a difference between module configuration information of the client apparatus and module configuration information of the server apparatus; and
a complementing unit configured to complement the module configuration information of the client apparatus based on the complementary data.

2. The client apparatus according to claim 1, wherein, based on the complementary data, the complementing unit installs at least one lacking module present in the module configuration information of the server apparatus, or
installs at least one surplus module present in the module configuration information of the client apparatus, or
overwrites at least one module, which is present in the module configuration information of the client apparatus, with an update module having a later update time than a module in the client apparatus.

3. A server apparatus configured to communicate with a client apparatus, the server apparatus comprising:
a module configuration information receiving unit configured to receive, from the client apparatus, module configuration information regarding at least one device driver installed in the client apparatus;
a detecting unit configured to detect a difference between module configuration information of the server apparatus and module configuration information of the client apparatus;
a complementary data producing unit configured to produce complementary data to compensate for the difference detected by the detecting unit; and
a complementary data transmitting unit configured to transmit the complementary data produced by the complementary data producing unit to the client apparatus.

4. The server apparatus according to claim 3, wherein, based on the module configuration information received by the module configuration information receiving unit, the detecting unit detects:
at least one lacking module present in the module configuration information of the server apparatus, or
at least one surplus module present in the module configuration information of the client apparatus, or
at least one update module that has a later update time than a corresponding module in the module configuration information of the client apparatus.

5. A method for a client apparatus configured to communicate with a server apparatus, the method comprising:
collecting module configuration information regarding at least one device driver installed in the client apparatus;
transmitting the module configuration information to the server apparatus;
receiving, from the server apparatus, complementary data compensating for a difference between module configuration information of the client apparatus and module configuration information of the server apparatus; and
complementing the module configuration information of the client apparatus based on received complementary data.

6. The method according to claim 5, wherein, based on the complementary data, complementing the module configuration includes:
installing at least one lacking module present in the module configuration information of the server apparatus, or
installing at least one surplus module present in the module configuration information of the client apparatus, or
overwriting of at least one module, which is present in the module configuration information of the client apparatus, with an update module having a later update time than a module in the client apparatus.

7. A method for a server apparatus configured to communicate with a client apparatus, the method comprising:
receiving, from the client apparatus, module configuration information regarding at least one device driver installed in the client apparatus;
detecting a difference between module configuration information of the server apparatus and module configuration information of the client apparatus;
producing complementary data to compensate for a detected difference; and
transmitting the complementary data to the client apparatus.

8. The method according to claim 7, wherein, based on the module configuration information of the client apparatus, detecting a difference includes:
detecting at least one lacking module present in the module configuration information of the server apparatus, or
detecting at least one surplus module present in the module configuration information of the client apparatus, or
detecting at least one update module that has a later update time than the corresponding module in the module configuration information of the client apparatus.

9. A program stored in a computer-readable medium that causes a computer, configured to communicate with a server apparatus, to:
collect module configuration information regarding at least one device driver installed in the computer;
transmit the module configuration information to the server apparatus;
receive, from the server apparatus, complementary data compensating for a difference between module configuration information of the computer and module configuration information of the server apparatus; and
complement the module configuration information of the computer based on received complementary data.

10. A program stored in a computer-readable medium that causes a computer, configured to communicate with a client apparatus, to:
receive, from the client apparatus, module configuration information regarding at least one device driver installed in the client apparatus;
detect a difference between module configuration information of the computer and the module configuration information of the client apparatus;
produce complementary data to compensate for a detected difference; and
transmit the complementary data to the client apparatus.
